(19) United States
(12) Patent Application Publication
(10) Pub. No.: US 2024/0083343 A1
(43) Pub. Date: Mar. 14, 2024

(54) METHOD FOR CONTROLLING THE ORIENTATION OF A LIGHT BEAM FOR A MOTOR VEHICLE, AND MOTOR VEHICLE

(71) Applicant: FERRARI S.P.A., Modena (IT)

(72) Inventor: Andrea SECONDI, Modena (IT)

(21) Appl. No.: 18/462,995

(22) Filed: Sep. 7, 2023

(30) Foreign Application Priority Data
Sep. 12, 2022 (IT) 102022000018474

(51) Int. Cl. B60Q 1/08

(52) U.S. Cl. CPC B60Q 1/085; B60Q 2300/112; B60Q 2300/32

(57) ABSTRACT

A method for controlling the orientation of a light beam for a motor vehicle is described comprising the steps of i) adjusting the orientation of a light beam arranged at the front relative to a normal forward moving direction of the motor vehicle; ii) acquiring a map of a path followed by said motor vehicle; iii) acquiring a current position of the motor vehicle along the path; and iv) defining a point of the path to which to orient the light beam, based on the map and on the current position; and v) rotating the light beam relative to the motor vehicle so as to light the point before the motor vehicle reaches the point.

### CROSS-REFERENCE TO RELATED APPLICATIONS

This patent application claims priority from Italian patent application no. 102022000018474 filed on 12 Sep. 2022, the entire disclosure of which is incorporated herein by reference.

### TECHNICAL FIELD

The present invention relates to a method for controlling the orientation of a light beam for a motor vehicle and to a motor vehicle.

### BACKGROUND

Motor vehicles are known that comprise the following:
a pair of front wheels;
a steering mechanism comprising, in turn, a steering wheel that can be driven to rotate the front wheels so as to enable the motor vehicle to follow a curved trajectory; and
a front lighting assembly designed to generate a light beam that lights the front zone of the motor vehicle.

Front lighting assemblies are also known that are operationally connected to the steering mechanism so as to orient the light beam on a horizontal plane and on one side of the motor vehicle, so as to enable the light beam to light a curved region of the road profile.

For example, according to a known solution, the lighting assembly is rotated by an angle associated or coinciding with a steering angle imposed by the driver on the front wheels via the steering wheel of the steering mechanism.

In the sector, it is known that the driver anticipates with their gaze the driving trajectory set in relation to the steering action imposed on the steering mechanism via the steering wheel.

As a result, the driver turns their gaze towards the curved region of the road profile before driving the steering wheel.

Therefore, the driver visually perceives the curved region as still not lit right in the moments immediately preceding the actual setting of the steering action.

This situation generates the risk that the driver does not readily, visually perceive any obstacles or people present in the curved region of the road profile towards which the motor vehicle is proceeding.

There is a need, in the sector, to improve the comfort of the driver, enabling them to visually perceive, suitably in advance, the obstacles or people present in the curved region of the road profile.

### SUMMARY

The purpose of the present invention is to produce a method for controlling the orientation of a light beam for a motor vehicle, which makes it possible to meet the need mentioned above.

The above-mentioned purpose is achieved with the present invention, as it relates to a method for controlling the orientation of a light beam for a motor vehicle according to what is defined in claim 1.

The present invention also relates to a motor vehicle according to what is defined by claim 7.

### BRIEF DESCRIPTION OF THE DRAWINGS

In order to better understand the present invention, a non-limiting preferred embodiment thereof will now be described by way of example with reference to the accompanying drawings, in which:

FIG. 1 is a perspective view of a motor vehicle produced according to the present invention;

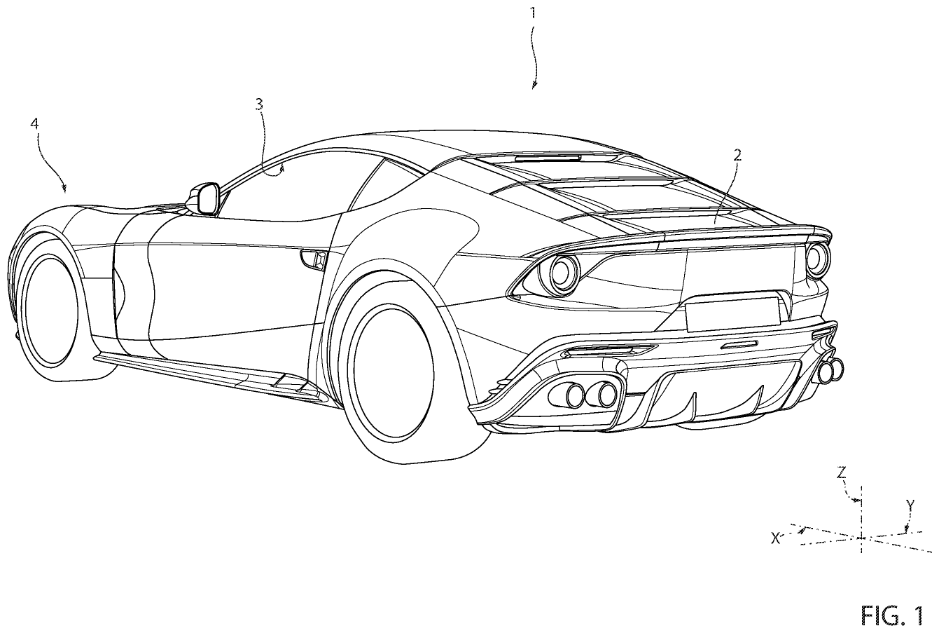

FIG. 2 is a view from above of the motor vehicle in FIG. 1 in a phase of driving along a straight region of a road path immediately preceding a curved region of the path itself; and

FIG. 3 is a functional diagram of some components of the motor vehicle in FIG. 2, with parts removed for clarity.

### DESCRIPTION OF EMBODIMENTS

With reference to the attached figures, reference number 1 indicates a motor vehicle comprising a body 2 defining a passenger compartment 3 and a front lighting assembly 4.

It should be specified that, below in this description, expressions such as “above”, “below”, “in front of”, “behind” and the like are used with reference to the normal movement of the motor vehicle 1.

It is also possible to define:
a longitudinal axis X integral with the motor vehicle 1, arranged, in use, horizontal and parallel to a normal forward moving direction of the motor vehicle 1;
a transversal axis Y integral with the motor vehicle 1, arranged, in use, horizontal and orthogonal to the axis X; and
an axis Z integral with the motor vehicle 1, arranged, in use, vertical and orthogonal to the axes X, Y.

The lighting assembly 4 can be driven to generate a light beam F in a region in front of the motor vehicle 1.

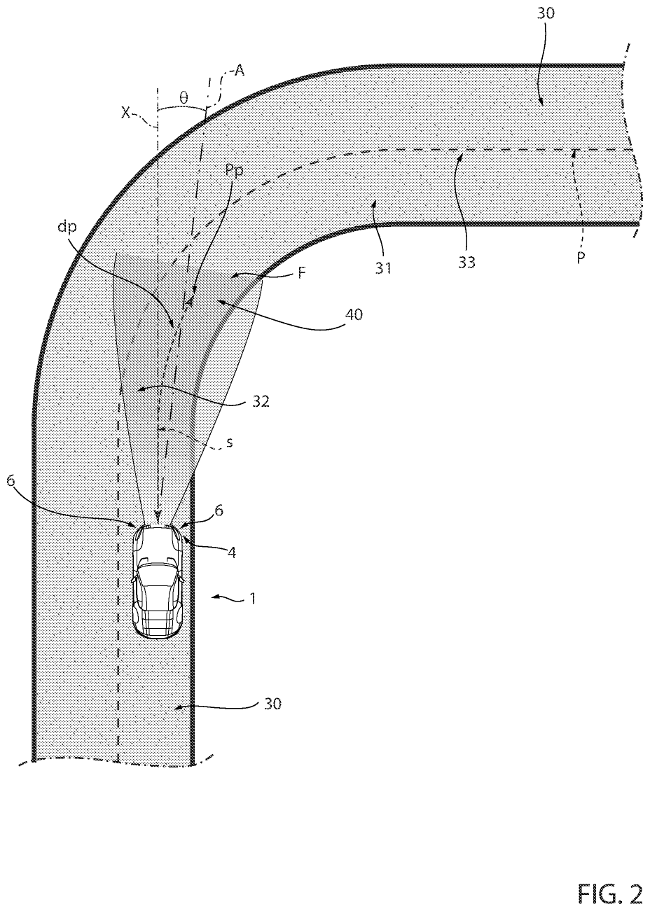

In a first embodiment illustrated in FIG. 2, the lighting assembly 4 comprises a pair of headlamps 6 that can rotate around respective axes parallel to the axis Z, so as to rotate the orientation of the light beam F.

In a second embodiment not illustrated, the lighting assembly 4 comprises a pair of left and right units formed, each one, from multiple LED lights that can be selectively operated, so as to rotate the orientation of the light beam F.

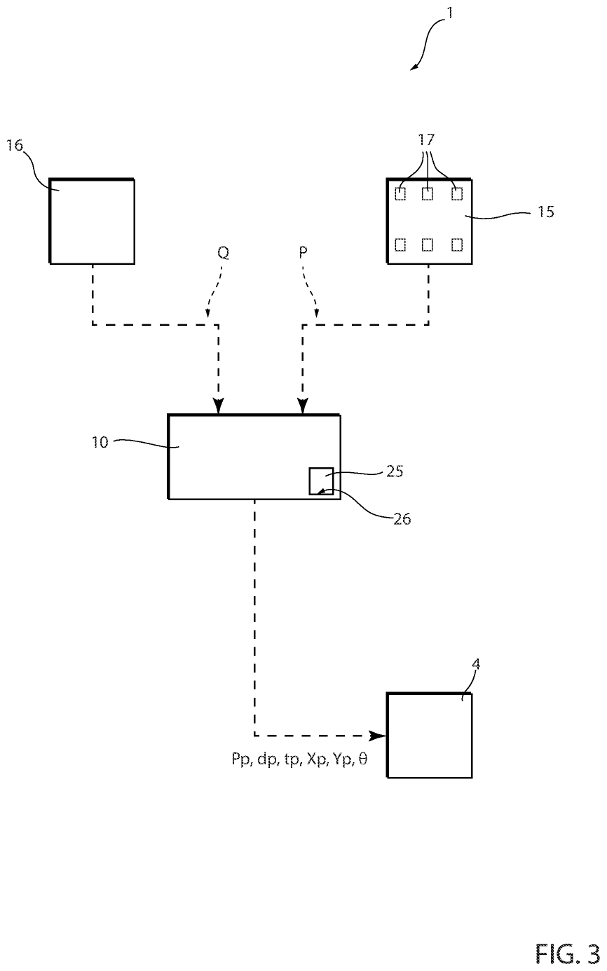

The motor vehicle 1 also comprises a processing unit 10 (only schematically illustrated in FIG. 3) programmed to control the lighting assembly 4, so as to adjust the orientation of the light beam F on a plane orthogonal to the axis Z and arranged, in use, horizontally.

More specifically, the processing unit 10 is programmed to adjust the orientation of the light beam F on both sides of the motor vehicle 1.

The motor vehicle 1 also comprises, only schematically illustrated in FIG. 3:
a database 15 comprising multiple maps 17 defining a road path P of the motor vehicle 1; and
a device 16, for example a GPS receiver, able to acquire the current position of the motor vehicle 1 on the path P.

Advantageously, the processing unit 10 is programmed (FIG. 2) for:
acquiring a map 17 of a path P followed by the motor vehicle 1 from the database 15;
acquiring a current position Q of the motor vehicle 1 along the path P from the device 16;
defining a point Pₚ of the path P to which to orient the light beam F, based on the map 17 and on the above-mentioned current position Q; and
rotating the light beam F relative to the motor vehicle 1 so as to light the point Pₚ before the motor vehicle 1 reaches the point Pₚ.

More specifically, the processing unit 10 is programmed to continuously process over time a value of an angle θ of rotation of an axis A of the light beam F relative to the direction X of the motor vehicle 1, so as to light a region 40 of the path containing the point Pₚ.

It is important to highlight that the rotation of the light beam F occurs without its being necessary to act on a steering mechanism of the motor vehicle 1.

The axis A indicates the symmetry axis of the two components of the light beams F generated by the respective headlamps 6 or unit of the lighting assembly 4.

In particular, the map 17 comprises, among other things, multiple straight sections 30 (only one of which is illustrated, for simplicity, in FIG. 2) and multiple curved sections 31 (only of which is illustrated for simplicity in FIG. 2).

For illustrative simplicity, reference will be made, below in this description, to just one section 30 and to the only section 31 immediately subsequent to it along the path P.

With reference to FIG. 2, the section 31 extends between one initial end 32 arranged at the end of the section 30 and one end 33 that is terminal with reference to the forward direction of the motor vehicle 1 along the path P.

The processing unit 10 is programmed to:
define a time interval (tₚ); and
process a distance dₚ between the point Pₚ and the motor vehicle 1, based on said time interval tₚ and on a moving speed of the motor vehicle 1.

More precisely, the distance d p is equal to the product of the time interval tₚ and the moving speed of the motor vehicle 1.

The distance dₚ is measured along a curved abscissa s parallel to the path P.

In particular, the time interval tₚ represents how much earlier the axis A of the light beam F is rotated by an angle θ relative to the moment when the motor vehicle 1 reaches the end 32 of the section 31.

The processing unit 10 is also programmed for:
processing the coordinates xPₚ, yPₚ of said point Pₚ relative to the motor vehicle 1 placed at a distance dₚ from the motor vehicle along the curved abscissa s parallel to the path P; and
controlling the lighting assembly 4 to rotate the light beam F by the angle θ relative to the motor vehicle 1, based on said coordinates xPₚ, yPₚ of said point Pₚ so as to light the region 40 of the section 31 containing the point Pₚ.

The angle θ is processed, in the example illustrated, as

$$atan ( \frac{y P p}{x P p} ) .$$

In particular, the processing unit 10 comprises a storing stage 25 (only schematically illustrated in FIG. 3) in which a table 26 (also only schematically illustrated in FIG. 3) is stored, which associates multiple values of the time interval tₚ with the corresponding values of the speed of the motor vehicle 1.

In the example illustrated, the table 26 associates increasing values of the time interval tₚ with the corresponding values of the moving speed of the motor vehicle 1 parallel to the axis X.

In one embodiment, the values of the time interval tₚ contained in the table 26 increase (decrease) with the decreasing (increasing) of the values of the moving speed of the motor vehicle 1 parallel to the axis X.

The values of the time interval tₚ contained in the table 26 preferably increase (decrease) linearly as the values of the moving speed of the motor vehicle 1 parallel to the axis X decrease (increase). In particular, a piece of software is uploaded to the processing unit 10 and implements an algorithm that generates the value of the angle θ as described earlier.

The operation of the motor vehicle 1 is described, at first, with reference to the condition of FIG. 2, wherein the motor vehicle 1 follows a straight section 30 of the path P in the direction of the section 31 immediately subsequent to the path P.

The processing unit 10 continuously acquires over time the map 17 associated with the path P from the database 15 and the current position Q of the motor vehicle 1 from the device 16.

The processing unit 10 also processes continuously over time the value of the angle θ of rotation of the axis A of the light beam F so as to light the region 40 of the section 31 of the path P containing the point Pₚ before the motor vehicle 1 reaches the end 32 of the section 31.

More specifically, the processing unit 10 defines the time interval tₚ based on the moving speed of the motor vehicle 1.

The processing unit 10 also processes the value of the distance dₚ between the point Pₚ and the motor vehicle 1 along the curved abscissa s parallel to the path P, based on the time interval tₚ and a moving speed of the motor vehicle 1.

Finally, the processing unit 10 processes the coordinates xPₚ, yPₚ of said point Pₚ relative to the motor vehicle 1 based on the distance dₚ measured along the curved abscissa s parallel to the path P; and rotates the axis A of the light beam F of the angle θ relative to the direction X based on said coordinates xPₚ, yPp of said point Pₚ, so as to light the region 40 of the section 31 containing the point Pₚ.

The advantages enabled by the present invention will be apparent from an examination thereof.

More specifically, the processing unit 10 rotates the axis A of the light beam F so as to light the region 40 comprising the point Pₚ defined based on the map 17 and the path 16, before the motor vehicle reaches the region 40 comprising the point Pₚ.

In this way, the light beam F illuminates the region 40 when the driver turns their gaze on the region 40 itself before the motor vehicle reaches the end 31 of the section 30.

As a result, the risk that the driver does not see suitably in advance obstacles or people present in the region 40 towards which the motor vehicle 1 is proceeding is largely avoided or at least reduced.

This results in a substantial improvement in the safety and comfort of driving associated with the motor vehicle 1.

Finally, it is clear that changes may be made to the method and motor vehicle 1, and variations produced thereto, according to the present invention that, in any case, do not depart from the scope of protection defined by the claims.

1.- A method to control the orientation of a light beam (F) for a motor vehicle (1) comprising the steps of:
i) adjusting the orientation of a light beam (F) arranged at the front relative to a normal forward moving direction of said motor vehicle (1);
ii) acquiring a map (17) of a path (P) followed by said motor vehicle (1);
iii) acquiring a current position (Q) of said motor vehicle (1) along said path (P); and
iv) defining a point (Pₚ) of said path (P) to which to orient said light beam (F), based on said map (17) and on said current position (Q); and
v) rotating said light beam (F) relative to said motor vehicle (1) so as to light said point (Pₚ) before said motor vehicle (1) reaches said point (Pₚ);
said step iv) comprising the steps of:
vi) defining a time interval (tₚ); and
vii) processing a distance (dₚ) between said point (Pₚ) and said motor vehicle (1) along a curved abscissa (s) parallel to said path (P), based on said time interval (tₚ) and on a moving speed of said motor vehicle (1);
characterized in that it comprises the step viii) of storing a table (26) associating said time interval (tₚ) with said moving speed of said motor vehicle (1);
said table (26) associating increasing values of said time interval (tₚ) with corresponding decreasing values of said moving speed of said motor vehicle (1).

2.- The method according to claim 1, characterised in that said table (26) associates linearly increasing values of said time interval (tₚ) with corresponding, linearly decreasing values of said moving speed of said motor vehicle (1).

3.- The method according to claim 1, characterized in that said step iv) comprises the steps of:
ix) processing the coordinates (xPₚ, yPₚ) of said point (Pₚ) relative to said motor vehicle (1); and
x) orienting said light beam (F) by an angle (θ) relative to a first, longitudinal axis (X) of said motor vehicle (1), based on said coordinates (xPₚ, yPₚ) of said point (Pₚ).

4.- The method according to claim 1, characterized in that said step v) comprises the step xi) of rotating a headlamp and/or the step xii) of selectively turning on and off one or more LEDs of a lighting device (4).

5.- The method according to claim 1, characterized in that said step v) comprises the step xiii) of orienting said light beam (F) in a plane orthogonal to a second axis (Z) of said motor vehicle (1); said second axis (Z) being orthogonal to said first longitudinal axis (X) of said motor vehicle (1) and orthogonal to a normal forward moving direction of said motor vehicle (1) and orthogonal to a third transverse axis (Y) of said motor vehicle (1) and orthogonal to said first axis (X).

6.- A computer product loadable into the memory of a processing unit (14) and capable of implementing, when it is executed, the steps of a method according to claim 1.

7.- A motor vehicle (1) comprising:
a lighting device (4) designed to generate an orientable light beam (F) arranged at the front relative to a normal forward moving direction of said motor vehicle (1);
a database (15) comprising a map (17) of a path (P) followed, in use, by said motor vehicle (1);
acquisition means (16) acquiring a current position (Q) of said motor vehicle (1); and
a processing unit (10) programmed to adjust the orientation of said light beam (F);
said processing unit (10) being programmed to:
i) acquire said map (17) from said database (15);
ii) acquire a current position (Q) of said motor vehicle (1) along said path (P) from said acquisition means (16);
iii) define a point (Pₚ) of said path (P) to which to orient said light beam (F), based on said map (17) and on said current position (Q); and
iv) rotate said light beam (F) relative to said motor vehicle (1) so as to light said point (Pₚ) before said motor vehicle (1) reaches said point (Pₚ);
said processing unit (10) also being programmed to:
define a time interval (tₚ); and
process a distance (dₚ) between said point (Pₚ) and said motor vehicle (1) along a curved abscissa (s) parallel to said path (P), based on said time interval (tₚ) and on a moving speed of said motor vehicle (1);
characterized in that said processing unit (10) comprises a storing stage (25), where a table (26) is stored, which associates said time interval (tₚ) with said moving speed of said motor vehicle (1);
said table (26) associating increasing values of said time interval (tₚ) with corresponding decreasing values of said moving speed of said motor vehicle (1).

8.- The motor vehicle according to claim 7, characterized in that said processing unit (10) is further programmed to:
process the coordinates (xPₚ, yPₚ) of said point (Pₚ) relative to said motor vehicle (1); and
orient said light beam (F) with an angle (θ) relative to a fixed direction of said motor vehicle (1), based on said coordinates (xPₚ, yPₚ) of said point (Pₚ).

9.- The motor vehicle according to claim 7, characterized in that said lighting device (4) comprises, in turn:
an orientable headlamp (6); and/or
a plurality of LEDs, which can selectively be activated.

10.- The motor vehicle according to claim 7, characterized in that said light beam (F) is orientable in a plane orthogonal to a second axis (Z) of said motor vehicle (1); said second axis (Z) being orthogonal to said first longitudinal axis (X) of said motor vehicle (1), orthogonal to a normal forward moving direction of said motor vehicle (1), and orthogonal to a third transverse axis (Y) of said motor vehicle (1) and orthogonal to said first axis (X).

11.- The method according to claim 7, characterised in that said table (26) associates linearly increasing values of said time interval (tₚ) with corresponding, linearly decreasing values of said moving speed of said motor vehicle (1).
